(19) United States
(12) Patent Application Publication
(10) Pub. No.: US 2015/0158666 A1
(43) Pub. Date: Jun. 11, 2015

(54) PORTION CAPSULE HAVING AN IDENTIFICATION ON THE INNER PERIPHERY THEREOF

(71) Applicant: K-FEE SYSTEM GMBH, Bergisch Gladbach (DE)

(72) Inventors: Marc Krüger, Bergisch Gladbach (DE); Günter Empl, Bergisch Gladbach (DE)

(21) Appl. No.: 14/411,579

(22) PCT Filed: Jul. 1, 2013
(86) PCT No.: PCT/EP2013/063800

§ 371 Date: Dec. 29, 2014

(30) Foreign Application Priority Data
Jun. 29, 2012 (DE) 10 2012 105 790.7
Jun. 19, 2013 (DE) 10 2013 211 568.7

(51) Int. Cl. B65D 85/804; B65B 61/26; B29C 51/08; B65B 7/28

(52) U.S. Cl. CPC B65D 85/8043; B65B 7/2871; B65B 61/26; B29C 51/08; B29L 2031/7174

(57) ABSTRACT

The present invention relates to a portion capsule (1) for preparing a beverage comprising a base member (2) having a cavity (3) in which a beverage raw material is provided and which is closed by a membrane (4) which is fixed to a base element (2), wherein it has an identifier (7), which makes it possible to individualise the respective portion capsule. In addition, the present invention relates to a process for the production of a portion capsule, and the use of the portion capsule for making a beverage.

The present invention relates to a portion capsule for preparing a beverage comprising a base element having a cavity in which a beverage raw material is provided and which is closed by a membrane which is fixed to the base element, wherein it comprises an identifier, which makes it possible to individualise the respective portion capsule. In addition, the present invention relates to a process for the production of a portion capsule and the use of the portion capsule for making a beverage.

Now, such portion capsules are well known and are offered in a variety of forms in the market and used to produce coffee, espresso, cappuccino, tea, milk or cocoa drinks and also other beverages or foods such as soups. To be used automatically, these capsules all have the same outer shape, although the respective manufacturing method is different. For example, the amount of water and/or the temperature that is used for the production of the respective beverage differ. In addition, the water of the portion capsule can be fed either continuously or intermittently through the portion capsule. The machines which are used to produce the particular beverage or foodstuff must be cleaned on a regular basis, for which purpose cleaning capsules are available, whose outer dimensions are identical to the dimensions of the portion capsules and which are also permeated by water after they have been introduced into the machine, which releases the cleaning substance from the capsules and with the solution cleans the brewing chamber of the machine and the downstream lines. It is essential to avoid the risk that a user, such as a child or a visually impaired adult, uses the cleaning capsule for producing a beverage and consumes it.

It is therefore the task of the present invention to provide a portion capsule which does not have the disadvantages of the prior art.

The object is achieved with a portion capsule for preparing a beverage comprising a base element having a cavity in which a beverage raw material is provided and which is closed by a membrane which is fixed to the base element, wherein the portion capsule has an identifier that makes it possible to individualise the respective portion capsule, wherein the identifier is placed on the inside of the base element and/or of the membrane.

The disclosure on this subject of the present invention applies equally to the other objects of the present invention and vice versa.

The present invention relates to a portion capsule for producing a beverage or foodstuff, which has a cavity in which a beverage raw material is placed. Such a portion capsule is made for example of plastic, a natural substance and/or a biodegradable material and has a base element, in particular a moulded base element, preferably thermo-formed, or produced by spray-extraction, which preferably is frusto-conical or cylindrical in shape and hats a bottom. In the cavity of the portion capsule the beverage raw material is introduced, which is extracted for example from a liquid, especially water, and/or dissolved. Preferably, the base element is sealed after the filling of the beverage raw material, in particular with a membrane. The membrane is preferably placed opposite the bottom of the base element. The membrane may be made of the same or different material as the base element and is preferably fixed by sealing and/or adhesive bonding to the base element. The membrane may be gaseous and/or liquid-tight or gaseous and/or liquid-pervious. In addition, a liquid distributor, one or more built-in elements, such as a filter, a liquid distributor, a fleece, a felt, a blocking film and/or similar, may be placed in the cavity. In the event that a felt and a fleece are provided, they are preferably connected to each other. The felt and/or the fleece can be multilayered, wherein the layers may differ in the type of raw material used and/or its processing. The membrane and/or the base may be provided with a plurality of recesses (holes).

According to the invention it is further provided that such portion capsule has an identifier that makes it possible to customise the respective portion capsule.

Individualising according to the invention preferably means that the respective portion capsule can be assigned to a group which is suitable for the preparation of a beverage or food or for cleaning the machine. It is not necessary that the identifier to disclose what portion capsule it is specifically, i.e. a serial number or batch number or similar, but only allows the classification of the respective portion capsule in a group of portion capsules, for example beverage/foodstuff portion or cleaning capsule. Preferably, the identifier also allows for differentiation between the different drinks and/or food types, for example, that it is a capsule with which tea, coffee, milk drink or similar or a soup can be made.

Preferably a sensor/detection device on a vending machine, for example a coffee vending machine, records this identifier and compares it preferably with a stored identifier. Preferably, the machine must only be put into operation, in particular its water-providing pressure pump, when the detected identifier matches the reference identifier of a beverage/food portion capsule. Otherwise, the coffee machine is not put into operation because it is possible that there is a cleaning capsule in it in which, for example, there is a cleaning agent. In this case, the machine may only be put into operation when for example a certain key combination is pressed on the control panel of the machine allowing the user to verify that it is known that there is a cleaning capsule present. This reliably prevents a cleaning capsule from accidentally being used for beverage production.

The identifier may alternatively or additionally serve to ensure that the coffee machine runs a specific programme, i.e. for example, the water is heated to a specific temperature, a certain pressure is achieved and/or a specific amount of water passes through the portion capsule.

Alternatively or additionally, the identifier is used for sorting the materials from which the portion capsule is produced for a subsequent disposal and/or recycling process.

According to the invention the identifier is placed on the inside of the base element and/or the inside of the membrane, i.e. in the cavity. This protects the identifier against damage and/or manipulation.

Preferably, the identifier is on and/or in a film, i.e. a foil, especially a plastic film, which preferably has food regulatory approval and which is connected to the base element and/or the membrane on the inside after it has been moulded, for example, thermo-formed or made by spraying/injection moulding, and/or while it is being moulded or produced by spraying/injection moulding. The identifier can thereby be applied to the film, before it is connected to the base element of the portion capsule. This can then be connected to the portion capsule without the identifier being damaged or its information content becoming unreadable.

Preferably, the bond between the base element and/or the membrane and the film having the identifier is frictional and/or form-fitting. Alternatively or in addition, there is a material connection between the base element and the film, for example by bonding or sealing.

Preferably, the identifier is on the side facing the portion capsule, so that after the placing of the film on the membrane or the base element it is between the membrane and/or the base element and the film. The identifier is thereby protected by the film.

The identifier may also be placed on the membrane, however, for example by a film on which the identifier is placed being connected to the membrane. Preferably, the identifier is then placed between two layers of film.

The film on which the identifier is placed, however, can also be one of several layers, which the membrane or the base element is made from. Preferably, the identifier is then placed between two layers of film.

Preferably, the film is to be implemented in multiple layers and the identifier is preferably placed between two layers of film.

Preferably, the identifier is applied by printing onto the film or any layer of the film.

According to another or a preferred subject of the present invention, the identifier is applied to the inner surface of the base element or a membrane or between two foil layers of the membrane and/or of the base element, for example by printing or some other method of application.

The disclosure on this subject of the present invention applies equally to the other objects of the present invention and vice versa.

According to the invention, or preferably, therefore, the identifier is applied to the membrane or the base element, for example as an additional layer or intermediate layer. This layer is preferably annular or circular and, therefore, preferably extends only locally but around the entire inner circumference of the base element and/or is preferably provided as a circular ring or circle on the membrane.

The identifier may, for example, the applied with a nozzle or using a brush or by printing, in particular with a pressure roller or similar, for example to the inner periphery of the base element or to the membrane or to a foil layer of the membrane and/or of the base element.

Preferably, the base element of the portion capsule has at least one ring which runs in particular parallel to the bottom and/or the flange of the portion capsule and improves the force and/or form fit between the film carrying the identifier and the base element of the portion capsule. Preferably, a plurality of parallel rings are provided.

Preferably, the film stretches around the entire inner circumference of the base element, but still more preferably along the entire length of it. Preferably, the film is provided as a cylinder surface or frustoconical surface. The identifier preferably extends around the entire inner and/or outer periphery of the film. Preferably, the identifier is annular.

Preferably, the identifier consists of surface areas having a particular optical characteristic, for example a reflection property and/or property of fluorescence and/or phosphorescence, which is recognisable by a sensor. This surface area is provided on the film with the identifier, which is placed on the base element and/or the membrane. Preferably, the film with the identifier has the base element and/or at least two regions on the membrane, which differ in their optical properties, for example their reflective properties and/or fluorescence properties and/or phosphorescence.

The identifier may, for example, be a visually detectable material, such as a fluorescent and/or phosphorescent substance. In addition, it may or an identifier in the form of a metal layer or ferrous metal layer and/or in the form of a metal or ferro-metal strip.

A fluorescent substance according to the invention consists of at least one molecule, with at least one electron, which when excited by the electromagnetic radiation is preferably removed from its orbital and lifted to a preferably empty, unoccupied molecular orbital of a higher energy content. This excited state is usually not stable, so that the electron falls back to its original orbital and its energy is at least partially released in the form of electromagnetic radiation. This liberated electromagnetic radiation is preferably of a longer wavelength than the exciting electromagnetic radiation. With an identifier which is based on a fluorescent substance, a sensor receives the released radiation and a connected controller compares the profile and/or the intensity of this radiation with a stored profile. If they are at least partially identical, the connected controller knows that it is a portion and not a cleaning capsule and the machine is released. Alternatively or additionally, the controller recognises what it is a portion capsule for, such as tea, coffee, milk or similar, and sets the machine accordingly. Preferably, the released radiation has at least one, more preferably several, maxima. The sensor or the connected controller then investigate whether at least one of these maxima is present in the radiation received.

A phosphorescent substance according to the invention comprises at least one molecule with at least one electron that, when excited by electromagnetic radiation, is preferably removed from its orbital and raised to a preferably empty, unoccupied molecular orbital with a higher energy content. This excited state is usually not stable, so that the electron falls back to its original orbital and its energy is at least partially released in the form of electromagnetic radiation. This liberated electromagnetic radiation is of a preferably longer wavelength than the exciting radiation. In a phosphorescent substance emission of radiation does not end with the end of the irradiation but extends over a longer period than is the case with fluorescence. With an identifier that is based on a phosphorescent substance, a sensor that is provided in or on the machine receives the released radiation and a connected controller compares this decay profile with a stored decay profile or profile section. Preferably, the intensity of this radiation, more particularly at a particular frequency, is compared with a stored decay profile and/or a specific value. If they are at least partially identical, the connected controller knows that it is a portion and not a cleaning capsule and the machine is released. Alternatively or additionally, the controller recognises what the portion capsule is for, such as tea, coffee, milk or similar, and controls the machine accordingly. The sensor or the connected controller assesses the period after which the original intensity of the radiation has decayed by a certain percentage and compares the measured value with a stored value. Alternatively or additionally, it is examined how great is the intensity of the radiation, in particular at a certain frequency, after a certain period of time and this value is compared with a stored value. If the recorded value matches the measured value, the controller releases the machine or selects a particular preparation programme for the particular beverage or food. If the value does not match, the machine can be taken only into operation under certain conditions since it could also be a cleansing capsule.

The fluorescent and/or phosphorescent substance is irradiated with a specific electromagnetic radiation and, during and/or after the radiation has been switched off, the fluorescence and/or phosphorescence is measured. The radiation may be carried out with one wavelength or multiple wavelengths. The radiation can include one or more sources, which are used simultaneously or in succession,

There may be one or more sensors which analyse the light emitted from the fluorescent and/or phosphorescent substance radiation. The sensor is preferably provided in the machine, for example its brewing chamber or in the area of the insertion chute.

The substance is applied to the base element or the membrane or to a film layer of the base element or membrane, for example by printing. The substrate for the identifier preferably has FDA approval.

In addition, the membrane and/or the base element may also have a decorative print. This decorative print may be placed on the visible side of the portion capsule before the substance of the identifier.

In a further preferred embodiment, the identifier is an electrically conductive area that is provided on or in the film, the base element and/or the membrane. By this electrically conductive area a measurable change is caused in an arbitrarily designed circuit, which then leads to the detection of the respective portion capsule and/or the electrically conductive area is detected by a sensor. To distinguish the respective portion capsules, they may have a different conductivity as a result of the film/foil and/or the imposition, which is detected by a sensor such as an ohmmeter. In a further preferred embodiment, the identifier is a magnetic, in particular ferromagnetic, area which is placed on the film or is applied to the base element and/or the membrane.

In a further preferred embodiment, the identifier is an RFID (radio frequency identifier). This RFID is provided on the membrane and/or the base element, in particular fastened, particularly preferably integrally connected, to it.

Preferably, the RFID a printed RFID. This RFID can be placed on the inside of the base element or the membrane, in particular, by being printed. The RFID, in particular the printed RFID, is preferably located between two layers of the film of the base element and/or the membrane and/or a film which is placed on the inside of the portion capsule. Preferably, the RFID is placed on an annular segment of material, in particular a sheet segment, which is connected to the flange of the base element. This connection can be produced by sealing or gluing. However, a moulded connection between the material segment and the base element is also conceivable. On the other hand, the RFID may also have a circular and/or circular annular structure on the inner side of the membrane and/or may be in the membrane.

In a preferred embodiment, the bond between the material segment on which the RFID is placed takes place during the thermo-forming of the base element because the material segment either simultaneously, before or afterwards, is attached to the base element or the material of which the base element is produced and preferably is sealed. Alternatively, the bond takes place between the material on which the RFID is placed and a further film layer by lamination.

Preferably, the RFID is placed on a plastic film and cut from it, preferably stamped. For example, an annular segment is separated from the foil. The RFID may have been previously laminated and/or printed onto the plastic film.

Preferably, the RFID is applied simultaneously with a decorative print on the inside of the portion capsule, or alternatively before or after attachment of the decorative printing.

In a preferred embodiment the identifier is achieved by a pigment, for example a colouring pigment and/or fluorescent pigment and/or phosphorescent pigment, which is placed in or on the film or on the inside of the base element or the membrane.

Preferably, the identifier is a substance that can be activated or modified, for example by an energy input.

With the portion capsule according to the invention, it is possible to prevent a cleaning capsule from inadvertently producing a beverage. In addition, it is possible by means of the identifier, that the machine recognises what type of capsule is in its brewing chamber and adjusts the beverage or food production process, i.e. four example, the amount of water, pressure and/or temperature appropriately.

According to a preferred subject of the present invention, a weakening is provided in the bottom area by removal of material, for example by means of a laser. This weakening is provided in particular in the area of the bottom of the capsule, which is pierced for the production of the beverage by a mandrel. The fact that the film in the area of the mandrel is weakened, for example by removal of material using a laser, means that the amount of force required to pierce the film is low. The mandrel of a corresponding coffee machine can have a force limit, for example in the form of a spring that limits the force with which the mandrel can press against the bottom of the portion capsule. Thereby it is avoided that capsules that do not have a corresponding weakening can be used in the relevant coffee machines.

According to a preferred subject of the present invention, the portion capsule has an edge area, which is preferably placed on the base element. Preferably, the edge is placed on the side opposite to the bottom area of the base element. At this edge area, for example, there can be a membrane for closing the base element, after the raw material is filled in the portion capsule. The border can also serve to guide the capsule into a chute so that it falls in a particular location in a brewing chamber or the brewing chamber is supplied in a very specific location. Simultaneously, the edge can serve as a touch and/or sealing surface.

A further preferred subject of the present invention is a portion capsule for making a beverage, comprising a substantially truncated-cone-shaped or cylindrical base element and a cavity for receiving a beverage raw material, as well as a cavity closing membrane, wherein the base element has a wall portion and the base element further comprises a bottom area on the membrane side facing away from the portion capsule, wherein the wall area has a plurality of grooves and the grooves between the membrane and the bottom area extended at least over part of the height dimension of the wall portion and in particular parallel to each other and are provided in parallel to the bottom area. These grooves preferably improve the bond between the portion capsule and the film with the identifier.

This portion capsule has, with respect to the portion capsule according to the prior art, for example the advantage that the wall area of the base element is stiffened by the large number of grooves. This has the advantage that the portion capsule has higher mechanical stability and thus deformation and, in particular, lateral buckling of the portion capsule is prevented. A further advantage of the portion capsule according to the invention is that an improved behaviour as the liquid flows through the portion capsule is ensured by the arrangement of grooves in the wall of the base element with the extraction of the liquid in the brewing chamber, because it is possible by the arrangement of the grooves, in particular by their flow between the membrane and the bottom area over at least part of the height dimension of the wall portion, to increase the quality and the reliability of the extraction process significantly. In particular, it is advantageously possible according to the invention that the material thickness of the base element can be reduced as a whole by increasing the mechanical stability due to the use of the large number of grooves. The production of the portion capsule is thus considerably more cost-effective and environmentally friendly. On the other hand, adhesion of the wall portion is reduced or avoided for the wall in the brewing chamber through the large number of grooves, so that ejecting or removing the portion capsule from the brewing chamber is made easier. Another advantage of the large number of grooves is that within the cavity can be designed to optimise the flow of the extraction liquid along the base area of the groove structure in the wall, for example, or so that by the formation of the groove structure better or stronger turbulence of the extraction liquid in the cavity or a more even (laminar) flow of the extraction liquid can be achieved by simple means. A stronger turbulence of the extraction fluid in the cavity in comparison to the prior art has the advantage over the prior art that there is no formation of unwanted and accidental main fluid flows through the bed of beverage raw material, but instead the beverage raw material is flowed through in its entire volume. The extraction process is thus much more efficient and can be controlled in a more precise or reproducible manner.

In particular, the beverage raw material includes coffee powder (preferably ground roasted coffee), chocolate powder, milk powder, tea or similar. Alternatively, it is conceivable that the beverage raw material includes a beverage extract, such as instant coffee.

Preferably, the base element has a shoulder on which particularly preferably there is an adjoining flange, wherein the base element in the area of the shoulder has a larger diameter than in the wall area between the shoulder and the bottom area. This results advantageously a particularly simple and robust way of stacking of the portion capsules or bringing about a stacking of the base element of the portion capsules.

Further, it is also preferably provided according to the invention that within the cavity a filter element is arranged, which divides the cavity into a first area for the ordering of the beverage raw material and a second area for receiving a beverage extract, and it is particularly preferably provided that the filter element comprises a fleece material and/or a felt material.

Another subject of the present invention is the use of a portion capsule according to the invention for the preparation of a hot beverage.

The disclosure on this subject of the present invention applies to the other objects of the present invention equally and vice versa.

Another subject of the present invention is a process for the preparation of a portion capsule, wherein the film having the identifier is connected with the base element during the thermo-forming or spraying, in particular plastic injection moulding, of it.

The disclosure on this subject of the present invention applies to the other objects of the present invention equally and vice versa.

Preferably, the film is connected, in particular as a ring, to a stamp of a thermo-forming tool with which the base element is then thermo-formed. Alternatively, the film is placed in a mould in which the material of the base element is injected. During hardening of the material, the film combines in particular cohesively with the material from which the base element is made.

Preferably, the film is provided as a closed ring.

Preferably, the film is provided as a hose.

Preferably, the film is sealed or glued to the base element.

Preferably, the film has ends which are connected to each other. This can be done before, during or after the connection to the base element.

A further preferred or according to the invention subject of the present invention is a process for the preparation of a portion capsule, in which the identifier is placed on the membrane or after thermo-forming or injection moulding on the inside of the base element.

The disclosure on this subject of the present invention applies to the other objects of the present invention equally and vice versa.

Preferably, the identifier is applied to the membrane or the base element, for example sprayed or brushed.

Alternatively or additionally, the attachment of the identifier is performed at the portion capsule or film by introduction of energy, in particular with a laser and/or by exposure. As a result, material is removed from the film, the membrane or the portion capsule and/or their optical, mechanical or other physical properties can be modified.

Preferably, the base element and/or the membrane for the provision of the identifier are rotated. More preferably, the base element is rotated in the thermoforming mould or injection mould.

Preferably, the order of the identifier takes place with a large number of nozzles that can be provided, for example, in the thermoforming mould or injection mould.

Yet another preferred object or the present invention is a method, wherein the identifier is applied after the sealing of the portion capsule to the base element and/or the membrane, or a film layer of the membrane or of the base element, and in particular is printed.

Both the identifier and the film are preferably made of a material that has food regulatory approval, i.e. may come into contact with foodstuffs.

According to another or a preferred subject of the present invention the identifier is applied on the inner, i.e. cavity-facing surface of the base element or membrane.

The disclosure on this subject of the present invention applies to the other objects of the present invention equally and vice versa.

According to the invention, or preferably, thereafter, the identifier is applied on the membrane or the base element, for example as an additional layer. This layer is preferably annular, thus extends preferably only locally but over the entire circumference of the base element and/or is preferably provided as a circular ring on the membrane.

The identifier is, for example, applied after the base element has been moulded, preferably thermo-formed, or has been injection moulded.

Preferably, the portion capsule has an edge area and/or flange which is placed on the base element.

According to a preferred subject of the present invention, there is a weakening is in the bottom area, by removal of material, for example by means of a laser. This weakening is provided in particular in the area of the bottom of the capsule, which is pierced for the production of the beverage by a mandrel. By virtue of the fact that the film is weakened, for example by removal of material using a laser in the area of the mandrel, the amount of force required to pierce the film is low. The mandrel of a suitable coffee machine can have a fourth limitation, for example in the form of a spring, by which the force is limited with which the mandrel can press against the bottom area capsule. Thereby it is avoided that capsules that do not have a corresponding weakening can be used in the relevant coffee machines.

The identifier is preferably attached to the base element after it is moulded, i.e., for example, has been thermo-formed or injection moulded.

According to another inventive or preferred subject of the present invention, it is envisaged that within the cavity a filter element is arranged, which divides the cavity into a first area for placing the beverage raw material and a second area for receiving a beverage extract, wherein it is provided particularly preferably that the filter element is a non-woven material and/or a felt material. Preferably, this material is connected with the ground, the wall and/or the border, in particular connected by sealing or gluing.

The disclosure on this subject of the present invention applies to the other objects of the present invention equally and vice versa.

Preferably, the filter element has the identifier, for example because the material from which the filter element is made is given, with the identifier, for example an electrically conductive or magnetic material. This substance can for example be made of components of the material of which the filter element is produced. For example, the threads may be part of the identifier from which the fleece or the felt is made. The filter element and/or the material from which the filter element is produced, however, may also be coated with the identifier.

Another subject of the present invention is the use of a portion capsule according to the invention for the preparation of a hot beverage.

The disclosure on this subject of the present invention applies to the other objects of the present invention equally and vice versa.

Another subject of the present invention is a process for the preparation of the portion capsule according to the invention, in which the film is inserted as a ring in the base element.

The disclosure on this subject of the present invention applies to the other objects of the present invention equally and vice versa.

Yet another subject of the present invention is a process for the preparation of a portion capsule, wherein the film is placed on the membrane, either during or after the thermo-forming or during or after the injection/moulding to the base element.

The disclosure on this subject of the present invention applies to the other objects of the present invention equally and vice versa.

Preferably for thermo-forming a stamp is used and the film is placed on the stamp, for example, at the periphery of the stamp. In thermo-forming, the film is then preferably connected to the base element.

Preferably, the film is provided as a closed ring. Preferably, the film is provided as a hose.

However, the film can also be associated with the base element during or after spray/injection moulding of it.

Preferably, the film is sealed or glued to the base element or the membrane.

Preferably, the film has ends which are connected to each other. This can be done before, during or after connection to the base element.

A further preferred or according to the invention subject of the present invention is a process for the preparation of a portion capsule, in which the identifier is placed on the membrane or after thermo-forming or injection moulding/injection moulding on the base element.

The disclosure on this subject of the present invention applies to the other objects of the present invention equally and vice versa.

Preferably, the identifier is applied to the membrane or the base element, for example sprayed or brushed.

Alternatively or additionally, the attachment of the identifier is performed to the portion capsule or film by introduction of energy, in particular with a laser. As a result, material is removed from the film, the membrane or the base element and/or their optical properties are changed.

Preferably the base element and/or the membrane is rotated for the provision of the identifier. Particularly preferably, the base element is rotated in the thermoforming mould/spray mould process.

Preferably the laying of the identifier takes place with at least one nozzle. The nozzle (s) can be provided in the stamp. Alternatively or additionally, the portion capsule can rotate when attaching the identifier.

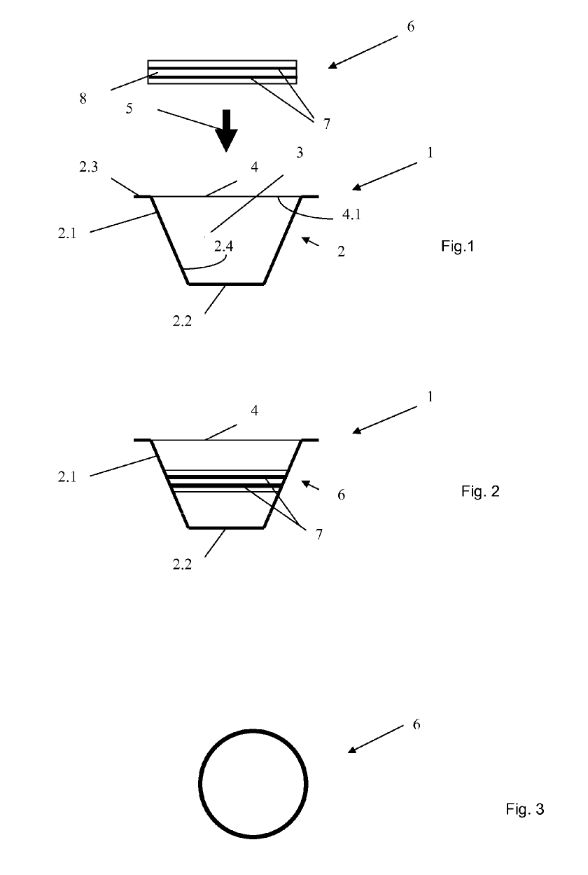

In what follows, the invention will be explained with reference to the FIGS. 1-5. These explanations do not limit the general inventive concept. The comments apply to all subjects of the present invention equally.

FIGS. 1 and 2 show a portion capsule with an identifier on a film.

FIG. 3 shows the film as a hose.

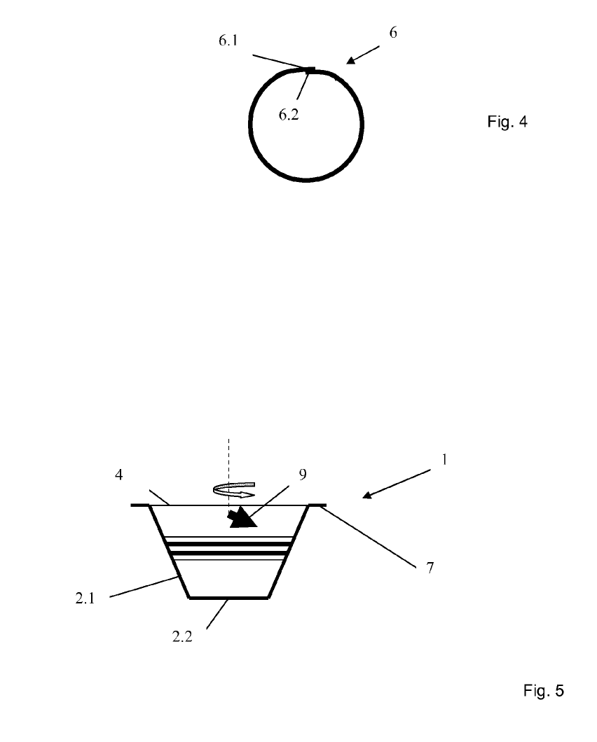

FIG. 4 shows a foil ring whose ends have been connected.

FIG. 5 shows a method for applying the identifier.

FIGS. 1 and 2 show a portion capsule 1, which has a base element 2 with a wall 2.1 and a bottom area 2.2. The wall 2.1 and the bottom 2.2 define a cavity 3 in which a beverage raw material and, if necessary, a built-in element can be placed. This cavity is preferably sealed after its filling by a membrane which is preferably connected to the edge area 2.4 of the base element, for example by sealing or gluing. This coffee portion capsule is inserted into a brewing chamber, in which it is traversed by a liquid, such as water. Here, the beverage raw material is extracted or dissolved, thereby producing the desired beverage. According to the invention this portion capsule now has an identifier 7, with which it can be determined whether the respective portion capsule is suitable for the preparation of a beverage or foodstuff. If this is not the case, significant health problems can arise. For example, and aqueous solution inedible for the user could be produced by using a cleaning capsule. This should be avoided. According to the invention this identifier 7 is provided on a film 6, in particular a plastic film, which, after the portion capsule has been moulded, as shown by the arrow 5, is inserted into the base element and connected to the inside of 2.4 of the base element 2 of the portion capsule. In the present case, the identifier 7 is divided into at least one, preferably two strips, which differ in their electrical conductivity and/or in their magnetic properties from the material of the film and/or of the material of the base element of the portion capsule. For example, the identifier has different conductivity or magnetic properties to at least one of the two materials and/or the area 8 between two identifiers 7. Preferably, the film 6 extends around the entire periphery of the base element. Particularly preferably each identifier 7 extends around the entire outer circumference of the film/film ring 6. After the film has been placed in the cavity 3 of the base element, it will be connected to it. The identifier may be applied or introduced to the film or as a part of the film, i.e. be inextricably linked with it. The person skilled in the art will appreciate that the identifier shown in FIG. 2 can also be effected by an ink applicator, which is described by way of example with reference to FIG. 5. The person skilled in the art will also recognise that the identifier can alternatively or additionally also be placed on the inside 4.1. of the membrane 4.

FIGS. 3 and 4 show that the film can be provided as a hose, which is cut to the desired length (FIG. 3). The identifier is for example applied to the film or the film is made of two materials, one having the identifier, for example a different electrical conductivity than the remainder. Alternatively, the ends 6.1, 6.2 of the film are connected to each other after its production. This can be done before the film is attached to the base element, when mounting or after mounting. The ends 6.1, 6.2 can, however, be provided with an impact or with a distance from each other.

In FIG. 5, another embodiment of the portion capsule of the invention is shown in a side view. In the present case, the identifier 7 is applied to the inside of the base element. The identifier is annular and is applied in the present case through a nozzle 9, which rotates during application. Alternatively or additionally, the portion capsule can rotate on the application of the identifier.

### LIST OF REFERENCE NUMBERS

1 Portion capsule
2 Base element
2.1 Wall
2.2 Bottom area
2.3 Edge area, flange
2.4 Inside of the base element
3 Cavity
4 Membrane
4.1 Inside of the membrane
5 Relative movement
6 Ring, film ring
6.1 End of the ring
6.2 End of the ring
7 Identifier, colour ring, barcode
8 Area next to an identifier
9 Nozzle

1. Portion capsule (1) for preparing a beverage comprising a base element (2) having a cavity (3) in which a beverage raw material is provided, and which is preferably closed by a membrane (4), which is fixed to the base element, wherein it has an identifier (5), which makes it possible to individualise the respective portion capsule, wherein the identifier (7) is located on the inner side (2.4, 4.1) of the base element and/or the membrane, characterised in that the identifier is placed on a film (6), which is connected to one or both of the base element and the membrane.

2. Portion capsule (1) according to claim 1, characterised in that the identifier (7) is on the outer surface of the base element (2) or a membrane (4) or between two layers of film of one or both of the membrane and of the base element.

3. Portion capsule (1) according to claim 1, characterised in that it comprises one or both of an edge portion and flange (2.3) which is placed on the base element (2).

4. Portion capsule according to claim 1, characterised in that in the cavity there is a filter element, which divides the cavity (3) into a first region (8) for receiving the beverage raw material and a second region (9) for receiving a beverage extract, and that the filter element has the identification.

5. Portion capsule (1) according to claim 1, characterised in that the identifier is an electrically conductive area (10).

6. Portion capsule (1) according to claim 1, characterised in that the identifier is a metallic area (11).

7. Portion capsule (1) according to claim 1, characterised in that the identifier is a ferromagnetic area (12).

8. Portion capsule (1) according to claim 1, characterised in that the identifier is an RFID.

9. Portion capsule (1) according to claim 5, characterised in that the filter element (5) comprises a non-woven material, in particular a felt or fleece material.

10. Use of a portion capsule (1) according to claim 1 for the preparation of a hot beverage.

11. Process for the preparation of a portion capsule according to claim 1, characterised in that the film (6) is inserted as a ring in the base element.

12. Process for the preparation of a portion capsule according to claim 1, characterised in that during deep drawing of the base element (2) the film (6) is connected to it.

13. Process for the preparation of a portion capsule according to claim 12, characterised in that a stamp is used for deep-drawing and that the film is placed on the stamp.

14. Method according to claim 1, characterised in that the film (6) is sealed or glued on the base element and/or the membrane.

15. Method according to claim 1, characterised in that the film (6) has ends (6.1, 6.2) which are joined together.

16. Process according to claim 15, characterised in that the film is made available as a hose.

17. Process for the production of a portion capsule according to claim 1, characterised in that the identifier (7) is placed on the membrane (4) before, during or after the deep-drawing or before, during or after the injection moulding/injection moulding on the base element (2).

18. Process according to claim 17, characterised in that the identifier (7) is applied, in particular by an application method.

19. Process according to claim 18, characterised in that the identifier (7) is effected by energy input.

20. Process according to claim 17, characterised in that the base element (2) or the portion capsule (1) is rotated for the provision of the identifier, in that the base element is rotated in the thermoforming mould, in that the identifier is applied with at least one nozzle, in that the nozzle rotates, or in that the identifier is applied with a pressure roller.

21. (canceled)

22. (canceled)

23. (canceled)

24. (canceled)

25. (canceled)

26. (canceled)
